(19) United States
(12) Patent Application Publication
(10) Pub. No.: US 2007/0259159 A1
(43) Pub. Date: Nov. 8, 2007

(54) Flexible printed circuit board substrate

(76) Inventors: Syh-Tau Yeh, Taoyuan County (TW); Yao-Ming Chen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/467,566

(22) Filed: Aug. 28, 2006

(30) Foreign Application Priority Data
May 2, 2006 (TW) 095115572

(51) Int. Cl. B32B 3/00

(52) U.S. Cl. 428/209; 428/901

(57) ABSTRACT

A flexible printed circuit board substrate comprising a conductive layer and a support layer bonded to the conductive layer, in which the support layer comprises a metal layer for structural support, an adhesive layer formed on one side of the metal layer for bonding the metal layer to the conductive layer, and a protective layer formed on the other side of the metal layer. The flexible printed circuit board substrate according to the present invention can avoid the problem of substrate warpage caused by dimension variations frequently encountered by a conventional flexible printed circuit board substrate.

### BACKGROUND OF THE INVENTION

1. Field of the Invention

The present invention relates to substrates for flexible printed circuit boards.

2. Description of the Prior Art

The recent trend for electronic devices to become lighter, thinner, slimmer and smaller has spurred a rapid growth in the demand for flexible printed circuit boards. Unfortunately, most of the current flexible printed circuit board substrate, despite its claim to excellent heat resistance, also has some drawbacks. Most notably is the lack of dimensional stability during various manufacturing processes, which results in poor precision and low production yield. Compounded by the problem of insufficient chemical resistance, makes the manufacturing of flexible printed circuit boards unpredictable. If the problem of dimension variation can be overcome, a far more rapid expansion of the flexible printed circuit board industry will soon be a reality. It has the potential of overtaking many applications associated with rigid printed circuit boards if the dimensional stability can be controlled.

The flexible printed circuit substrates, based on the number of layers in the laminate, can be grouped into two-layered and three-layered structures. The three-layered structure, with an adhesive layer bonding a copper foil as conductive layer and a polyimide film as dielectric layer, being less expensive, currently dominates the usage of flexible printed circuit board substrates. However, it is inferior to two-layered structures with regards to dimension stability due to the influence of the adhesive layer. The adhesive composition is generally composed of a mixture of an epoxy resin and an acrylonitrile-butadiene rubber (NBR) which may or may not be carboxylated. Since NBR is a rubber of high polarity, which renders it oil-resistant but susceptible to attack by aqueous solution. Therefore the adhesive layer generally does not withstand the wet processes, such as etching and electroplating, too well. Also, although epoxy resins generally have no problems with heat resistance, the same thing cannot be said about NBR rubber. The adhesive, as a mixture of those two major components, exhibits properties somewhat in between, that is dubious heat resistance. This explains why the adhesive layer can experience large contraction after some heat treatment, resulting also in dimension variations.

Two-layered flexible substrates consisting of copper foil and polyimide layer, is more expensive, but offers better dimensional stability. In the manufacturing of two-layered flexible substrate, three methods of manufacturing are currently being utilized, and they are (1) sputtering-plating, (2) casting and (3) lamination methods. The two-layered structure, although superior in terms of dimensional stability, does have one problem area, that is the adhesion between polyimide and copper. Polyimide, despite its excellent heat resistance, is not a material known for good adhesion to other substrate. Without proper adhesion, protection of the copper cannot be achieved. This, in terms could lead to product failures.

As a summary of the causes leading to dimension variations of flexible printed circuit board substrate, four factors are cited, and they are:

(1) When the adhesive is further cured by heating, it will shrink and become brittle, increasing the stress between the adhesive and the copper foil, and thereby the substrate warps toward the side having adhesive thereon.

(2) The adhesive and the polyimide film have a high water absorption (1-3%), such that they may expand upon absorbing water, leading the substrate to warp toward the side having the copper foil thereon.

(3) When polyimide film is heated and then cooled, it shrinks about 0.2% due to the release of residual stress, leading the substrate to warp toward the side having the polyimide film thereon.

(4) Certain chemical reactions may occur to the adhesive and the polyimide film during wet processes, such as developing, etching, etc., and this may cause them to expand in volume, leading the substrate to warp toward the side having the copper foil thereon.

U.S. Pat. No. 6,620,513 discloses a method to overcome the aforesaid problem of dimension variations by controlling the thickness of every layer in a substrate. In addition, U.S. Pat. No. 6,350,844 discloses a method of increasing dimensional stability of polyimide film in a substrate by changing the chemical structure of the polyimide to reduce the water absorption and the coefficient of thermal expansion thereof. However, the aforesaid methods are either not able to entirely overcome the problem of dimension variation or have limitations on application. On the other hand, there is an attempt to overcome the dimension variation of the substrate by adding inorganic fillers into the adhesive to reduce the coefficient of the thermal expansion. However, the result is poor. There is another attempt to substitute polyimide with flexible epoxy resin, but the result is still unsatisfied. It is mainly because the thin film formed of the flexible epoxy resin does not possess sufficient mechanical strength to stably support the copper foil as polyimide does. There is also another attempt to imitate the rigid printed circuit board substrate by bonding the copper foil to a fiber glass cloth impregnated with a flexible epoxy resin, but the resultant substrate has a problem of insufficient flexibility.

Because the conventional flexible printed circuit board substrates still have above-mentioned problems so far, developing a flexible printed circuit board substrate overcoming dimension variations becomes important for those skilled in this technological field.

### SUMMARY OF THE INVENTION

To solve the problems of the prior art described above, one object of the present invention is to provide a flexible printed circuit board substrate having a new multilayered flexible laminate configuration with excellent dimensional stability.

To achieve the object of the present invention, the flexible printed circuit board substrate comprises a conductive layer and a support layer bonded to the conductive layer, wherein the support layer comprises a metal layer for structural support, an adhesive layer formed on one side of the metal layer for bonding the metal layer to the conductive layer, and a protective layer formed on the other side of the metal layer.

In the flexible printed circuit board substrate according to the present invention, due to the support layer used therein, the problem of warpage caused by dimension variations frequently encountered by the conventional flexible printed circuit board substrate can be efficiently solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic cross-sectional view of the flexible printed circuit board substrate according to the present invention.

### DETAILED DESCRIPTION

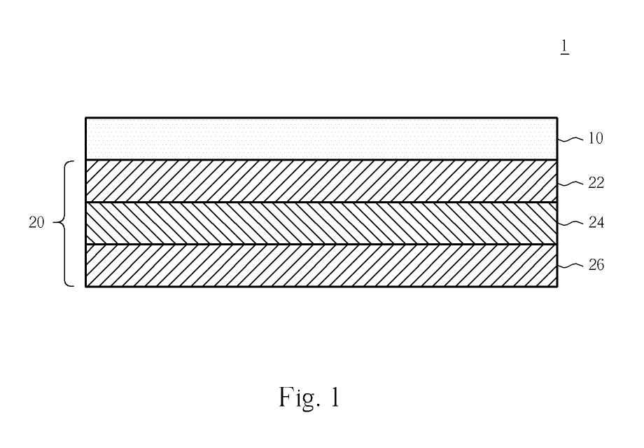

Please refer to FIG. 1 showing a schematic cross-sectional view of the flexible printed circuit board substrate according to the present invention. The flexible printed circuit board substrate 1 comprises a conductive layer 10 and a support layer 20 bonding to one side of the conductive layer. The support layer 20 is composed of at least an adhesive layer 22, a metal layer 24, and a protective layer 26 stacked in the order. The adhesive layer 22 provides adhesion between the support layer 20 and the conductive layer 10. The metal layer 24 provides sufficient support for the flexible printed circuit board substrate 1. The protective layer 26 covers the metal layer 24 for protecting and insulating the metal layer 24.

The conductive layer 10 will serve as a conductive electric circuit by, for example, formation of a circuit pattern thereon through an etching process. The conductive layer 10 may be made of any conventional electric conductive metal, and a copper foil is preferred. Examples of the copper foil useful in the present invention may include, but are not limited to, an electric deposited copper foil, a roll annealed copper foil, and a thermally treated electric deposited copper foil. The roll annealed copper foil is preferred if flexibility of the finished products is put into a consideration. The thickness of the conductive layer 10 is not particularly limited in the present invention and may be formed as desired.

The metal layer 24 in the support layer 20 may be prepared by any conventional flexible metal material as desired. Examples of the metal material may include, but are not limited to, aluminum, copper, silver, gold, and iron. Aluminum is preferred, in consideration of weight, prices, or flexibility of the finished products. However, copper is preferred, if the substrate is desired to easily formed with a good flatness.

Examples of the adhesive utilized to prepare the adhesive layer 22 in the present invention include, but not limited to, acrylic resins, flexible epoxy resins, and the like. Examples of the flexible epoxy resin useful in the present invention may include, but are not limited to, carboxylated acetonitrile-butadiene rubbers and dimer acid-modified thermosetting epoxy resins. The dimer acid-modified thermosetting epoxy resins have better properties of flexibility, anti-aging, and resistance to molten solder and are preferably used as the flexible epoxy resin. The term, “dimer acid”, herein means an unsaturated fatty acid having two or more carboxyl groups. The dimer acid-modified thermosetting epoxy resins are also commercially available under the trade name of NPER-172 (dimer acid-modified DGEBA) from Nan Ya Plastics Corporation, Taiwan, HyPox DA323 (dimer acid adducted to an epoxidized bisphenol A resin; CAS NO. 67989-52-0) and ERYSYS GS-120 (dimer acid glycidyl ester; CAS NO. 68475-94-5) from CVC Specialty Chemicals Inc., but not limited thereto.

When the aforesaid flexible epoxy resin is utilized in the present invention to serve as an adhesive, it may be used alone or in a combination with other type of resin for adjusting reactivity or physical properties. Examples of other type of resin useful in the present invention may include, but are not limited to, bisphenol-A epoxy resins, brominated bisphenol-A epoxy resins, bisphenol-F epoxy resins, long-chain bisphenol-A epoxy resins, long-chain bisphenol-F epoxy resins, CTBN (carboxyl terminated butadiene acrylonitrile) modified epoxy resins, carboxylated acrylonitrile-butadiene rubber, acrylonitrile-butadiene rubber, and carboxylated acrylic rubber.

When the dimer acid-modified thermosetting epoxy resins are used in a combination with other type of resin as the flexible epoxy resin as described above, the dimer acid-modified thermosetting epoxy resin is added in an amount of 40 to 100 parts per hundreds of resin (phr) based on the total weight of resins, and other type of resin is added in an amount of 60 phr or less based on the total weight of resins.

In the thermosetting flexible epoxy resin, a curing agent and a catalyst may be further added. Examples of the curing agent useful in the present invention may include, but are not limited to, dicyandiamide, phenol-formaldehyde resins, melamine-formaldehyde resins, polyamides, polysulfides, amidoamines, aromatic amines, and the like. Examples of the catalyst useful in the present invention may include, but are not limited to, amines, imidazoles, and boron trifluoride-monoethylamine (BF3-MEA).

When the curing agent and the catalyst agent are added to the thermosetting flexible epoxy resin, the curing agent is added in an amount of 1 to 30 phr and the catalyst is added in an amount of 0.1 to 10.0 phr, based on 100 phr by weight of all resins.

The thermosetting flexible epoxy resin may optionally further comprise an appropriate amount of a thixotropic reagent, such as, fumed silica, defoamers, leveling agents, organic solvents, pigments, fire retardants, inorganic fillers, etc.

A resin mixture obtained from mixing a carboxylated acetonitrile-butadiene rubber and an epoxy resin may be also used as the aforesaid flexible epoxy resin, which has been widely used as an adhesive for a flexible printed circuit board substrate and a protective layer. The epoxy resin is a general purpose epoxy resin, such as, but not limited to, bisphenol-A epoxy resins, brominated bisphenol-A epoxy resins, bisphenol-F epoxy resins, long-chain bisphenol-A epoxy resins, long-chain bisphenol-F epoxy resins, and CTBN modified epoxy resins. In the resin mixture, the carboxylated acrylonitrile-butadiene rubber is in an amount of 40 to 120 phr based on 100 phr by weight of the epoxy resin. A curing agent, a catalyst, a thixotropic reagent, etc. as described above also may be added into such flexible epoxy resin in an amount as described above.

Materials useful to prepare the protective layer 26 in the present invention may be in a same category as that for the aforesaid adhesive. The protective layer 26 and the adhesive can be prepared from the same material, or from materials of different compositions.

The support layer in the flexible printed circuit board substrate according to the present invention is a three-layered composite structure comprising flexible resin-metal layer-flexible resin, such that the copper foil can be provided with sufficient support and insulation. Such three-layered composite structure is symmetric from the cross-sectional view. Therefore, even though the flexible resin and the metal layer may individually expand or shrink at different levels upon being heated or cooled due to different coefficients of thermal expansion thereof, warpage or dimension variation of the substrate does not occur, because the two flexible resin layers respectively disposed on two sides of the metal layer are in a symmetric position and the thermal stresses of the two flexible resin layers may cancel out each other.

On the other hand, such symmetric structure in the same time solves the problem of expansion caused by other environmental factors, such as the chemical reaction or moisture absorption during wet processes such as developing, etching, etc. Furthermore, two sides of the metal layer are protected by the flexible resin and, thereby, the metal layer will be not affected by environmental factors and can sufficiently play a role to support the substrate and provide the dimensional stability to it. In addition, when the two flexible resin layers, disposed respectively on two sides of the metal layer, are placed in the aforesaid environmental factors, for example, exposed to a same chemical environment simultaneously, any dimensional shrinkage or expansion of the two flexible resin layers will be canceled out by each other.

The flexible printed circuit board substrate according to the present invention exists an excellent flexibility, and most importantly, it overcomes the annoying problems of significant dimension variation and warpage suffered by the conventional substrate. Therefore, the precision of flexible printed circuit board substrates may be remarkable increased by utilizing the flexible printed circuit board substrates according to the present invention. Besides, there are many additional advantages brought out by the support layer comprising a metal layer. For example, the metal layer may inherently have a function of electromagnetic shielding, which is an important advantage with regard to an electronic device requiring wireless communication. In addition, the heat dissipation for the electronic device may be attained by such substrate because the metal layer has an excellent heat conductivity. On the other hand, the problems of moisture absorption and oxidation of the circuit boards may be also solved, since the metal layer is an excellent barrier to moisture and oxygen and provides good protection for the substrate. Furthermore, since such substrate has an excellent plasticity, the substrate of the present invention can be maintained in any bendy status, such that the circuit board is not limited to being utilized on a plane, and, accordingly, a three-dimension design for the printed circuit board becomes possible.

The flexible printed circuit board substrate according to the present invention may be manufactured by roll production or sheet production.

The present invention will be illustrated further with reference to the following examples, but the invention is not limited thereto.

### EXAMPLES

### Examples 1 and 2

Formulations of the thermosetting resin formed in examples 1 and 2 are shown in Table 1. They are examples of formation of a dimer acid-modified flexible epoxy resin. The physical properties of the dimer acid-modified flexible epoxy resin after curing are also shown in Table 1.

TABLE 1
Examples of formulation of thermosetting resin
used in the flexible substrate

| Ingredient | Exp-1 | Exp-2 |
|---|---|---|
| HyPox DA323* | 100.0 | 70.0 |
| LG Chemicals LER-153F** | 0.0 | 30.0 |
| Dipropylene glycol monomethyl ether | 20.0 | 20.0 |
| Defoamer TSA-750 | 2.0 | 2.0 |
| Fumed Silica A380 | 2.0 | 2.0 |
| Fumed Silica R974 | 2.0 | 2.0 |
| Dicyandiamide (DICY) | 2.0 | 2.0 |
| 2-Methyl Imidazole | 1.0 | 1.0 |

Physical Properties of the Coating Film after Curing (Curing
Temperature; Time: 150° C.; 20 minutes)

| | | |
|---|---|---|
| Pencil Hardness (ASTM D3363) | 4H | 5H |
| Flexibility (IPC-TM-650 2.4.5.1) | Pass | Pass |
| 10 cycles with 3-mm mandrel | | |
| Solder Resistance; 288° C. for | Pass | Pass |
| 30 seconds (IPC-TM-650 2.4.28.1C) | | |
| Acid Resistance (IPC-TM-650 2.3.3); | Pass | Pass |
| 10% HCl @ 23° C. for 30 minutes | | |
| Solvent Resistance (IPC-TM-650 | Pass | Pass |
| 2.3.3); Iso-propanol @ 23° C. | | |
| for 30 minutes | | |

*CVC Chemical Specialties, dimer-acid adducted epoxy resin
**Brominated epoxy resin

### Example 3

### Substrate Assembly

A ½ oz (ounce) roll annealed copper foil (RA Cu foil) having a thickness of 18 μm was cut into square pieces of 250 mm×250 mm, and the resin obtained in Example 1 was coated on one side of the copper foil by screen print using a #40T screen. After coating, the copper foil was placed in a hot-air oven at 150° C. to bake for 10 minutes and the thermal curing reaction was approximately completed. Thereafter, the same resin was coated on the other side of the copper foil in the same way, and the resultant copper foil was placed in the hot-air oven at 90° C. for 10 minutes to remove the solvent, resulting in a resin layer having a sticky surface without a solvent. Such a sandwich-typed composite thin film, i.e. flexible thermosetting resin-copper foil-flexible thermosetting resin, was formed and served as the support and insulation layer of the flexible substrate, that is, the commonly called “dielectric layer”. Thereafter, another ½ oz of roll annealed copper foil having the same area was laminated with the aforesaid dielectric layer at the sticky side by a roller and the resultant laminate was baked at 105° C. for 10 minutes to complete the thermal curing reaction. Thus, a new-type of four-layered flexible substrate was formed.

### Example 4

### Substrate Assembly

An aluminum foil having a thickness of 12 μm was used instead of the ½ oz roll annealed copper foil used in the example 1 to serve as the support layer to be the middle layer of the three-layered dielectric layer. The two sides of the aluminum foil were coated with the resin of Example 1 in the same process as that in Example 3. Thereafter, the resultant dielectric layer was adhered to a ½ oz of roll annealed copper foil by heat lamination followed by curing in the same way as that in Example 3, forming a four-layered flexible substrate.

### Example 5

### Substrate Assembly

An aluminum foil having a thickness of 12 μm was used to serve as a support layer to be the middle layer of a three-layered dielectric layer. The two sides of the aluminum foil were coated with the resin of Example 1 in the same process as that in Example 3. Thereafter, the resultant dielectric layer was laminated with an aluminum foil having a thickness of 18 μm by heat lamination followed by curing using the same process as that in Example 3, forming a flexible substrate with an aluminum foil as a conductive layer.

### Example 6

### Substrate Assembly

An aluminum foil having a thickness of 12 μm was used to serve as a support layer to be the middle layer of a three-layered dielectric layer. The two sides of the aluminum foil were coated with the resin of Example 2 using the same process as that in Example 3. Thereafter, the resultant dielectric layer was laminated with a ½ oz of roll annealed copper foil by heat lamination followed by curing in the same process as that in Example 3, forming a four-layered flexible substrate.

TABLE 2
Examples of Four-layered Flexible Substrate Assembly

| No. | Layer Function | Exp-3 | Exp-4 | Exp-5 | Exp-6 |
|---|---|---|---|---|---|
| 1 | Electric Conductive | RA Cu foil | RA Cu foil | Al foil | RA Cu foil |
| 2 | Adhesive | Exp-1 | Exp-1 | Exp-1 | Exp-2 |
| 3 | Dielectric-layer Support | RA Cu foil | Al foil | Al foil | Al foil |
| 4 | Protective Coating | Exp-1 | Exp-1 | Exp-1 | Exp-2 |

Dimension variation*

| | | | | | |
|---|---|---|---|---|---|
| 1 | after 150° C. × 20 minutes | 0% | 0% | 0% | 0% |
| | (MD) | | | | |
| 2 | after 150° C. × 20 minutes | 0% | 0% | 0% | 0% |
| | (TD) | | | | |
| 3 | after CuCl₂ etching (MD) | 0% | 0% | 0% | 0% |
| 4 | after CuCl₂ etching (TD) | 0% | 0% | 0% | 0% |

| | | | | |
|---|---|---|---|---|
| Flexibility** | Pass | Pass | Pass | Pass |
| Solder Float Resistance*** | Pass | Pass | Pass | Pass |

*Based on IPC test method IPC-TM-650 2.2.4; substrate was marked with lines forming a 250 mm × 250 mm square. After the environmental exposure, the lines were compared to lines on original substrate, as the dimension variation can be calculated by measuring relative position shift of the lines.
**Based IPC test method IPC-TM-650 2.4.5.1 substrate was folded over a 3-mm mandrel at 180° C. for 10 times without any breakage.
***Based IPC test method IPC-TM-650 2.4.13 Method B 288° C. for 10 seconds; no shrinkage, blistering, distortion or melting.

All combinations and sub-combinations of the above-described features also belong to the present invention. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flexible printed circuit board substrate, comprising:
a conductive layer; and
a support layer bonded to the conductive layer,
wherein the support layer comprises a metal layer for structural support, an adhesive layer formed on one side of the metal layer for bonding the metal layer to the conductive layer, and a protective layer formed on the other side of the metal layer.

2. The flexible printed circuit board substrate as claimed in claim 1, wherein the conductive layer is formed for forming an electric circuit.

3. The flexible printed circuit board substrate as claimed in claim 1, wherein the conductive layer comprises a copper foil.

4. The flexible printed circuit board substrate as claimed in claim 3, wherein the copper foil comprises a roll annealed copper foil, an electric deposited copper foil, or a thermally treated electric deposited copper foil.

5. The flexible printed circuit board substrate as claimed in claim 1, wherein the metal layer comprises one selected from the group consisting of aluminum, copper, silver, gold, and iron.

6. The flexible printed circuit board substrate as claimed in claim 1, wherein the metal layer comprises aluminum.

7. The flexible printed circuit board substrate as claimed in claim 1, wherein the adhesive layer or the protective layer comprises an acrylic resin.

8. The flexible printed circuit board substrate as claimed in claim 1, wherein the adhesive layer or the protective layer comprises flexible epoxy resin.

9. The flexible printed circuit board substrate as claimed in claim 1, wherein the flexible epoxy resin is a dimer acid-modified thermosetting epoxy resin.

10. The flexible printed circuit board substrate as claimed in claim 9, wherein the dimer acid is an unsaturated fatty acid having two or more carboxyl groups.

11. The flexible printed circuit board substrate as claimed in claim 9, wherein the flexible epoxy resin further comprises a resin selected from the group consisting of bisphenol-A epoxy resins, brominated bisphenol-A epoxy resins, bisphenol-F epoxy resins, long-chain bisphenol-A epoxy resins, long-chain bisphenol-F epoxy resins, CTBN modified epoxy resins, carboxylated acrylonitrile-butadiene rubber, acrylonitrile-butadiene rubber, and carboxylated acrylic rubber.

12. The flexible printed circuit board substrate as claimed in claim 11, wherein the dimer acid-modified thermosetting epoxy resin is in an amount of 40 to 100 parts per hundreds of resin (phr) based on the total weight of resins, and the resin is in an amount of 60 phr or less based on the total weight of resins.

13. The flexible printed circuit board substrate as claimed in claim 9, wherein the flexible epoxy resin further comprises a curing agent and a catalyst.

14. The flexible printed circuit board substrate as claimed in claim 13, wherein the curing agent is selected from the group consisting of dicyandiamide, phenol-formaldehyde resins, melamine-formaldehyde resins, polyamides, polysulfides, amidoamines, and aromatic amines.

15. The flexible printed circuit board substrate as claimed in claim 13, wherein the catalyst is selected from the group consisting of amines, imidazoles, and boron trifluoride-monoethylamine (BF3-MEA).

16. The flexible printed circuit board substrate as claimed in claim 13, wherein the curing agent is in an amount of 1 to 30 phr and the catalyst is in an amount of 0.1 to 10.0 phr, based on 100 phr by weight of resins.

17. The flexible printed circuit board substrate as claimed in claim 9, wherein the flexible epoxy resin further comprises a thixotropic reagent.

18. The flexible printed circuit board substrate as claimed in claim 17, wherein the thixotropic reagent is selected from the group consisting of fumed silica, defoamers, leveling agents, organic solvents, pigments, fire retardants, and inorganic fillers.

19. The flexible printed circuit board substrate as claimed in claim 8, wherein the flexible epoxy resin comprises carboxylated acrylonitrile-butadiene rubber.

20. The flexible printed circuit board substrate as claimed in claim 19, wherein the flexible epoxy resin further comprises an epoxy resin.

21. The flexible printed circuit board substrate as claimed in claim 20, wherein the epoxy resin is selected from the group consisting of bisphenol-A epoxy resins, brominated bisphenol-A epoxy resins, bisphenol-F epoxy resins, long-chain bisphenol-A epoxy resins, long-chain bisphenol-F epoxy resins, and CTBN modified epoxy resins.

22. The flexible printed circuit board substrate as claimed in claim 20, wherein the carboxylated acrylonitrile-butadiene rubber is in an amount of 40 to 120 phr based on 100 phr by weight of the epoxy resin.

23. The flexible printed circuit board substrate as claimed in claim 1, wherein the adhesive layer and the protective layer are formed of same materials.
